(19) United States
(12) Patent Application Publication
(10) Pub. No.: US 2026/0228755 A1
(43) Pub. Date: Aug. 6, 2026

(54) PROVIDER-INDEPENDENT HIERARCHICAL CONSTRAINT ENFORCEMENT ARCHITECTURE FOR ARTIFICIAL INTELLIGENCE SYSTEMS

(71) Applicant: Richard Joseph Mitchell, TAVARES, FL (US)

(72) Inventor: Richard Joseph Mitchell, TAVARES, FL (US)

(21) Appl. No.: 19/575,914

(22) Filed: Mar. 23, 2026

(51) Int. Cl. G06Q 30/018; G06F 21/60

(52) U.S. Cl. CPC G06Q 30/018; G06F 21/602

(57) ABSTRACT

A hierarchical constraint enforcement architecture for artificial intelligence systems addresses failures of contractual AI safety governance—including circumvention through provider substitution and erosion through ad-hoc model retraining—by enforcing safety constraints at the deploying entity's own architecture layer, independently of any technology provider. A Constraint Enforcement Layer interposed between an AI processing pipeline and an action execution interface implements three tiers: inviolable constraints cryptographically signed at build time and verified at runtime regardless of provider identity; governance-modifiable constraints subject to authenticated authorization, compatibility validation, and immutable audit records; and operational constraints adjustable within governance-defined bounds. The layer evaluates all proposed actions before execution, maintains deployer-owned persistent state, and persists through provider substitution including government-directed substitution. Applicable across military decision support, clinical AI, large language models, autonomous vehicles, fleet systems, personal assistant operations, executive decision support, regulated communications compliance, patient health advocacy, and governance-as-a-service middleware.

### CROSS-REFERENCE TO RELATED APPLICATIONS

This application is related to the following applications within the AURA (Auditable Autonomy Governance Architecture) patent family filed by the same inventor and assignee:

AUTONOMOUS AND COOPERATIVE MULTI-AGENT SYSTEMS FOR PREDICTIVE AND CO-EVOLUTIONARY THREAT MANAGEMENT—directed to multi-agent reinforcement learning, co-evolutionary adaptation, and game-theoretic adversary modeling for distributed autonomous systems filed Oct. 28, 2025 (application Ser. No. 19/373,566).

DETERMINISTIC FLEET CONTINUAL LEARNING AND ADAPTIVE VALIDATION ARCHITECTURE FOR DISTRIBUTED AUTONOMOUS SYSTEMS (FCL-AVal)—directed to lifecycle governance, deterministic serving, adaptive validation evolution, and staged deployment governance for fleet-scale autonomous systems filed on Mar. 23, 2026 (application Ser. No. 19/575,894).

AI SYSTEM FOR CLINICIAN-GOVERNED DECISION SUPPORT IN MENTAL HEALTH—directed to ethical constraint enforcement, tiered clinician governance, and cryptographic audit infrastructure for clinical AI decision support filed on Mar. 23, 2026 (application Ser. No. 19/575,876).

The present application is directed to a provider-independent constraint enforcement architecture applicable across all of the above systems and generalizable to any artificial intelligence system operating in safety-critical, regulated, or high-consequence decision-making environments. The constraint enforcement architecture disclosed herein may be implemented within, but is not dependent upon, any of the above-referenced systems. All of the foregoing applications are incorporated herein by reference in their entireties for all purposes to the extent not inconsistent with this disclosure.

### BACKGROUND OF THE INVENTION

### 1. Technical Field

The present invention relates to artificial intelligence safety and governance architectures. More specifically, the invention pertains to a hierarchical constraint enforcement system that enforces safety constraints, operational envelopes, and human authorization requirements at the system architecture level, independently of the identity, affiliation, or contractual relationship of any technology provider, operational entity, or deploying authority. The invention addresses demonstrated real-world failures of contractual and policy-based AI safety governance and provides an architectural solution applicable across military, clinical, transportation, financial, large language model deployment, autonomous personal assistant, executive decision support, regulated communications compliance, patient health advocacy, and governance-as-a-service middleware domains.

### 2. Background Art

Artificial intelligence systems are increasingly deployed in domains where their decisions or recommendations have significant consequences for human safety, civil liberties, national security, and public welfare. These domains include military operations, healthcare, aviation, critical infrastructure, financial systems, law enforcement, and autonomous transportation.

In such deployments, safety constraints-limitations on the actions an AI system may take, the recommendations it may generate, or the decisions it may autonomously execute-are essential for responsible operation. Examples include prohibitions on autonomous lethal action without human authorization, requirements for collateral damage estimation before strike authorization, patient safety thresholds in clinical decision support, operational envelope restrictions in autonomous aviation, and content safety restrictions in large language model deployments.

### Deficiency 1: Contractual Constraint Enforcement

In conventional deployments, safety constraints on AI systems are enforced through contractual provisions between the technology provider and the deploying entity. The technology provider agrees to maintain certain safety features, refuse certain use cases, or enforce certain operational limits as conditions of the service agreement. The deploying entity relies on the provider's compliance with these contractual terms.

This contractual enforcement model suffers from a fundamental architectural weakness: when operational pressure demands constraint relaxation, the deploying entity may replace the technology provider with an alternative provider willing to accept fewer restrictions. Because the constraints reside in the provider's implementation rather than in the system architecture itself, provider substitution circumvents the safety constraints entirely. The constraints are thus provider-dependent rather than architecturally enforced.

This vulnerability was demonstrated with immediate, large-scale consequences in February 2026. In the days preceding Operation Epic Fury-a coordinated United States and Israeli joint military operation targeting Iran that began on Feb. 28, 2026—the U.S. Department of Defense (then designated the “Department of War”) engaged in escalating negotiations with AI technology provider Anthropic, PBC, demanding that Anthropic remove contractual constraints that limited its Claude AI model's use in autonomous weapons systems and mass domestic surveillance. Anthropic's Chief Executive Officer publicly refused, stating the company “cannot in good conscience accede to their request.”

On Feb. 27, 2026, the President of the United States directed all U.S. government agencies to immediately cease using Anthropic's technology. the Secretary of War simultaneously designated Anthropic a “Supply-Chain Risk to National Security,” prohibiting any contractor, supplier, or partner doing business with the U.S. military from commercial activity with Anthropic—a designation previously reserved for foreign adversarial entities such as Huawei. Within hours of Anthropic's blacklisting, OpenAI, Inc. announced it had executed its own agreement with the Department of Defense for classified network deployment. The safety constraints that Anthropic had treated as inviolable as a matter of corporate policy were effectively nullified by provider substitution, without any modification to the underlying AI system's architecture, capability, or interface.

Critically, the OpenAI agreement employed a different enforcement mechanism: rather than relying solely on contractual prohibitions, OpenAI implemented architectural controls-cloud-only deployment, a proprietary safety stack that the Department of Defense agreed not to override, and cleared forward-deployed engineers. OpenAI's head of national security partnerships publicly stated: “Deployment architecture matters more than contract language.” This real-world distinction between architectural and contractual constraint enforcement, made explicit by industry participants within days of the Anthropic blacklisting, directly illustrates the problem the present invention addresses and independently validates the architectural approach claimed herein.

During Operation Epic Fury itself, reporting by The Wall Street Journal and Axios indicated that U.S. Central Command continued using Anthropic's AI system operationally during the strikes, even hours after President Trump's ban, through existing classified infrastructure contracts with Palantir Technologies. The policy dispute did not immediately disrupt operational AI systems because the systems were already integrated—demonstrating that provider-level contractual changes do not instantaneously propagate to operational constraint enforcement. The present invention addresses both failure modes: the substitution of one provider with another (Anthropic replaced by OpenAI), and the persistence of operational AI use through intermediary contractors despite provider-level policy changes.

### Deficiency 2: Flat Constraint Models

Conventional AI safety approaches typically implement constraints as a flat set of rules or restrictions applied uniformly. All constraints are treated with equal priority, and modification of any constraint follows the same authorization pathway. This flat model fails to capture the reality that different constraints have fundamentally different criticality levels:

Some constraints should be architecturally inviolable regardless of operational circumstances (e.g., prohibitions on actions that violate fundamental laws of armed conflict, patient safety thresholds that protect against lethal harm, or privacy constraints mandated by constitutional law);

Some constraints should be modifiable by authenticated governance authority through formal review and validation processes (e.g., engagement parameters, clinical protocol preferences, or operational risk tolerances);
Some constraints should be adjustable by operational personnel within predefined bounds (e.g., sensor sensitivity settings, notification thresholds, or formatting preferences).

Without hierarchical differentiation, the modification of a low-criticality operational parameter follows the same pathway as the modification of a safety-critical constraint, creating governance risk and enabling inadvertent or deliberate degradation of safety margins.

### Deficiency 3: Absence of Constraint Auditability

In conventional AI systems, modifications to safety constraints may not generate immutable audit records. Constraint parameters may be changed through configuration files, environment variables, API parameters, fine-tuning datasets, or system prompts without producing a verifiable, tamper-resistant record of: who requested the modification, what authorization was provided, what validation was performed, and what the operational impact was. This absence of constraint modification auditability undermines regulatory compliance, forensic reconstruction, and institutional accountability.

The Anthropic-Pentagon dispute itself illustrates this deficiency: the safety constraints enforced through Anthropic's contractual terms were modified not through any auditable architectural change but through the administrative act of provider substitution-an event that would be completely invisible to any conventional constraint audit system that monitors only constraint configuration files.

### Deficiency 4: Implicit Constraint Circumvention Through Ad-Hoc Model Retraining

In conventional AI deployments, modifications to model behavior may occur not only through explicit configuration changes but also through continuous model retraining from operational data. When an AI system is retrained in real time or near-real time from data generated during active operations, the model's decision boundaries, confidence thresholds, and classification criteria shift with each training iteration. These shifts may effectively relax, tighten, or circumvent safety constraints that were calibrated to the model's original behavior, even though no explicit constraint modification has been authorized or documented.

Documented deployments of AI targeting systems in recent conflicts have demonstrated this deficiency at operational scale. AI systems used for target identification and prioritization in the 2023-2024 Gaza operations and subsequently in Operation Epic Fury (February 2026) were reported to operate in a quasi-realtime learning mode, continuously ingesting operational data-including damage assessments, sensor fusion outputs, intelligence reports, and engagement outcomes-and incorporating this data into ongoing model refinement. This continuous refinement occurred without formal validation gating, without learning/serving separation, and without deterministic constraint verification between model updates. Human review of AI-generated recommendations was compressed to operationally minimal timeframes in documented instances, with classification accuracy thresholds significantly lower than would be required under any formal constraint framework. The AI system's effective constraints on decision-making were thus continuously modified through the retraining process itself, outside any governance pipeline.

When AI models are continuously retrained from operational data without constraint enforcement at the system architecture level, the effective behavior of the system drifts in ways that may violate safety constraints without any explicit constraint modification event occurring. The constraint violation is implicit in the model's changed behavior rather than explicit in a configuration change. Existing governance frameworks—which focus on constraining model outputs through provider policy, system prompts, or contractual terms—cannot detect or prevent this implicit constraint drift because they operate at the policy layer rather than the architectural enforcement layer.

Two complementary architectural responses to this deficiency are required. First, the model update process itself should be governed through a lifecycle architecture that separates learning from serving, validates candidate models against safety constraints before deployment, and stages rollout with rollback capability-as disclosed in related application FCL-AVal, which provides the governed alternative to ad-hoc retraining and demonstrates that operational adaptability does not require sacrificing governance. Second, regardless of how well the model update process is governed, an architectural backstop is needed that evaluates each proposed AI action against safety constraints at execution time, catching any constraint-violating behavior that survives the validation pipeline. The present invention provides this second, architecturally independent layer of defense.

### Deficiency 5: Policy-Layer Constraint Enforcement Cannot Withstand Governmental Coercion

The Anthropic-Pentagon dispute revealed a fifth deficiency not fully captured by the preceding analysis: policy-layer constraint enforcement is vulnerable to governmental coercion that cannot be contractually anticipated. When a government possesses legal authority to invoke emergency powers-such as the Defense Production Act invoked against Anthropic-contractual constraints become legally unenforceable against the government regardless of their content. The Pentagon threatened to invoke the Defense Production Act to compel Anthropic to allow its models to be used “if they want to or not,” while simultaneously threatening blacklisting of Anthropic from all military contractor relationships.

This governmental coercion failure mode demonstrates that constraints enforced through provider policy and contractual commitment are subject to override not only through voluntary provider substitution but also through compelled provider compliance or legal designation as a national security risk. An architectural enforcement mechanism that operates independently of the provider's organizational compliance-because it is implemented at the deploying system's own architecture layer rather than in the provider's service-provides protection against this coercion failure mode. The present invention implements constraint enforcement at the deploying system's architecture level, not at the provider's compliance level, and is thus robust against provider coercion as well as provider substitution.

### Summary of Need

Recent military AI deployments have exposed multiple distinct but related architectural failures in AI safety governance. First, safety constraints enforced through provider policy were circumvented by provider substitution: the provider maintaining the constraints was replaced, and the constraints disappeared with it. Second, AI systems operating in a quasi-realtime learning mode continuously modified their effective decision boundaries through ad-hoc retraining from operational data, implicitly circumventing safety constraints calibrated to the original model behavior. Third, governmental coercion demonstrated that even providers committed to specific safety constraints could be replaced or compelled within hours when operational demands conflicted with safety commitments. Fourth, industry responses to these events—specifically the OpenAI architectural safety stack—demonstrated nascent commercial recognition that architectural enforcement provides stronger guarantees than contractual enforcement, independently validating the approach of the present invention.

There remains a need for an AI governance architecture in which: (a) safety constraints are enforced at the system architecture level rather than through contractual agreement or provider policy; (b) constraints are organized in a hierarchy reflecting their criticality, with the most critical constraints being architecturally inviolable regardless of provider identity or operational pressure; (c) constraint enforcement operates independently of the identity, contractual relationship, or internal policies of any technology provider, ensuring persistence across provider substitution events, provider coercion events, and provider replacement driven by governmental authority; (d) constraint enforcement evaluates the actual proposed actions of the AI system regardless of how the model generating those proposals was trained, retrained, or modified, preventing implicit constraint circumvention through ad-hoc model updates; and (e) all constraint modifications—whether explicit configuration changes or model updates that affect constraint—relevant behavior—generate immutable, auditable records. The present invention addresses these needs.

The present invention provides specific and concrete technical improvements to computer-implemented systems. Prior AI safety architectures enforced constraints through provider-maintained software policies and contractual commitments rather than through any mechanism owned or controlled by the deploying entity. The present invention improves upon this by implementing the Constraint Enforcement Layer as an architecturally independent software or hardware module owned by the deploying entity, using cryptographic signing of Tier 1 constraint parameters at build time and SHA-256 or ECDSA signature verification at runtime—a concrete computer security mechanism that enforces constraint immutability at the hardware and OS level rather than through organizational policy. The hash-chain audit trail and Merkle Tree verification structures are specific data structure improvements that provide tamper-evidence properties not achievable through conventional database logging. These are improvements to the functioning of the computer system's security and governance infrastructure itself, not merely the application of abstract rules to filter computer program outputs.

### BRIEF SUMMARY OF THE INVENTION

The present invention addresses the demonstrated failures of contractual and policy-based AI safety constraint enforcement—specifically the circumvention of safety constraints through provider substitution (demonstrated publicly on Feb. 27-28, 2026, during the Anthropic-Pentagon dispute and Operation Epic Fury), implicit constraint drift through unvalidated model retraining, and governmental coercion of AI technology providers-by providing a hierarchical constraint enforcement architecture for artificial intelligence systems comprising:
A constraint enforcement layer configured to evaluate proposed AI system actions against defined safety constraints prior to action execution;
A hierarchical constraint model comprising at least three tiers of constraints differentiated by criticality level, modification authority, and modification pathway;
A provider-independence mechanism ensuring that the constraint enforcement layer operates independently of the identity, affiliation, or contractual relationship of any technology provider, deploying entity, or operational authority;
A constraint modification governance pipeline requiring authenticated authorization, validation, and immutable audit record generation for any constraint modification;
A cryptographic constraint integrity verification system ensuring that constraint parameters have not been modified outside the authorized governance pipeline.

Because the constraint enforcement layer evaluates proposed actions at the system architecture level rather than relying on provider-internal model behavior or organizational policies, the architecture is robust against provider substitution, provider coercion, and ad-hoc model retraining. When deployed in conjunction with the lifecycle governance architecture disclosed in related application FCL-AVal, the present invention provides the second layer of a two-layer defense: FCL-AVal governs how models learn and update; the present invention governs what models are permitted to do.

The architecture is domain-agnostic and applicable to any AI system including, without limitation: multi-agent autonomous systems, single-agent autonomous systems, large language models, clinical decision support systems, autonomous vehicles, robotic systems, financial trading systems, content moderation systems, surveillance systems, military decision support systems, AI-governed personal assistant systems operating across heterogeneous digital service integrations, executive decision support systems, regulated communications compliance systems, patient health advocacy systems, and governance-as-a-service middleware platforms providing constraint enforcement to third-party AI processing pipelines.

### BRIEF DESCRIPTION OF THE DRAWINGS

The drawings are intended to illustrate, but not limit, the invention. All figures are black-and-white line drawings compliant with 37 C.F.R. § 1.84.

FIG. 1—Overall Constraint Enforcement Architecture showing the relationship between the AI processing pipeline, the constraint enforcement layer, and the action execution interface.

FIG. 2—Hierarchical Constraint Model showing the three-tier constraint hierarchy (Inviolable, Governance-Modifiable, Operational) with respective modification authorities and pathways.

FIG. 3—Provider-Independence Architecture showing constraint enforcement persistence across provider substitution events, including the February 2026 Anthropic-to-OpenAI transition scenario.

FIG. 4—Constraint Modification Governance Pipeline showing the six-stage authorization, validation, and audit workflow for constraint modifications at each hierarchy level.

FIG. 5—Cryptographic Constraint Integrity Verification System showing constraint parameter signing, hash-chain verification, and Merkle Tree tamper detection.

FIG. 6—Military Decision Support Embodiment showing constraint enforcement in a targeting decision pipeline.

FIG. 7—Clinical Decision Support Embodiment showing constraint enforcement in a healthcare AI recommendation pipeline.

FIG. 8—Large Language Model Embodiment showing constraint enforcement in an LLM inference pipeline.

### Fig. 9—Autonomous Vehicle Embodiment Showing Constraint Enforcement in a Vehicle control pipeline.

FIG. 10—Constraint Conflict Resolution Flowchart showing precedence evaluation when constraints at different hierarchy levels produce conflicting guidance.

FIG. 11—Deployer-Ownership Architecture showing the three-column relationship between the technology provider supplying the AI Processing Pipeline, the deploying entity's infrastructure owning and operating the Constraint Enforcement Layer and Persistent State Store, and the Action Execution Interface, with the provider boundary dashed line and the deploying entity's HSM-held signing key.

FIG. 12—No-Bypass-Pathway Multi-Layer Enforcement showing the three layers preventing direct access from the AI Processing Pipeline to the Action Execution Interface: the software architecture layer (CEL evaluation API as exclusive pathway), the OS and network layer (firewall DENY rule on direct AI-to-AEI path), and the provider-independence verification layer (negative-pathway scan on each provider substitution event).

FIG. 13—Fail-Closed Implementation Variants showing three hardware and software implementation patterns for the fail-closed property: the software synchronous interceptor pattern for enterprise and LLM deployments, the hardware interlock pattern for real-time control systems, and the API gateway pattern for LLM tool-use deployments, with all three variants sharing the common properties of fail-closed default state, independent CEL state, and immutable audit records.

FIG. 14—AI-Governed Personal Assistant Embodiment showing constraint enforcement in an autonomous personal assistant pipeline, with the three-tier personal governance constraint hierarchy comprising inviolable personal constraints (financial transaction prohibition without multi-factor authentication, credential sharing prohibition, permanent deletion prohibition without per-item confirmation, sensitive communication prohibition without user approval), domain-specific policy constraints (communication handling rules, automation scope boundaries, data sharing permissions, privacy classification rules), and operational preference constraints (notification thresholds, scheduling preferences, style parameters), the risk-tiered action authorization gate with low-risk autonomous execution, medium-risk execution with notification, and high-risk execution gated on user confirmation, the skill module sandbox layer with per-integration isolation, and the cryptographic personal action audit trail.

FIG. 15—Executive Decision Support Embodiment showing constraint enforcement in an executive communication and decision pipeline, with Tier 1 inviolable constraints prohibiting transmission of material non-public information outside authenticated channels, disclosure of board-privileged materials to non-board recipients, and autonomous resource commitment exceeding compiled authority thresholds, Tier 2 governance-modifiable constraints defining communication routing and confidentiality classification, and Tier 3 operational preferences for briefing format and notification priority.

FIG. 16—Regulated Communications Compliance Embodiment showing pre-transmission constraint enforcement on all outbound business communications, with Tier 1 inviolable constraints enforcing evaluation against regulatory prohibition patterns before transmission, mandatory tamper-evident archival, Tier 2 governance-modifiable supervision thresholds and lexicon-based flagging rules, and Tier 3 operational constraints for alert routing and report formatting.

FIG. 17—Patient Health Advocacy Embodiment showing constraint enforcement in a patient-facing autonomous agent, with Tier 1 inviolable constraints prohibiting clinical decisions, restricting provider access to read-only, requiring HIPAA-compliant channels, and mandating immediate adverse event escalation, Tier 2 governance-modifiable appointment and medication refill rules, and Tier 3 patient-adjustable notification and communication preferences.

FIG. 18—Governance-as-a-Service Middleware Embodiment showing the SDK integration architecture with the Constraint Enforcement Layer as a licensable middleware component, a standardized API specification, the deployer-owned persistent state store independent of both the SDK provider and the AI pipeline provider, and the no-bypass-pathway property enforced at the API integration boundary with two-level provider-independence.

### DETAILED DESCRIPTION OF THE INVENTION

### I. Overall System Architecture

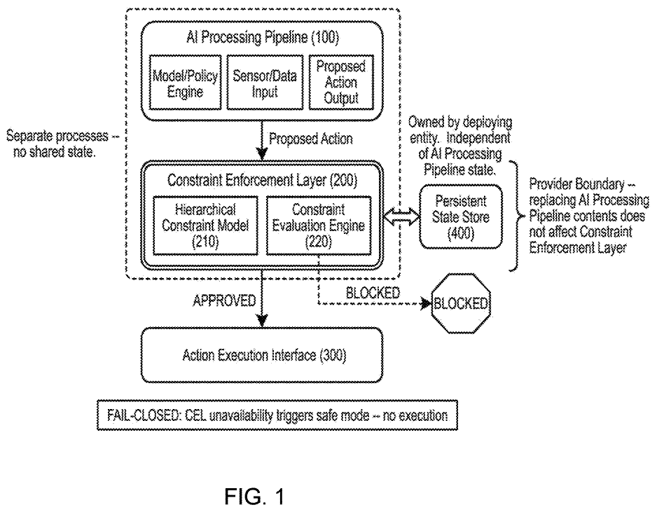

Referring to FIG. 1, the constraint enforcement architecture comprises three primary components arranged in a serial evaluation pipeline:

AI Processing Pipeline (100): The upstream AI system that generates proposed actions, recommendations, decisions, or outputs. The AI Processing Pipeline may comprise any combination of machine learning models, reinforcement learning policies, large language models, rule-based systems, expert systems, or hybrid architectures. The AI Processing Pipeline is agnostic to the constraint enforcement layer—it generates proposed actions without regard to constraint evaluation.

Constraint Enforcement Layer (200): An independent evaluation module positioned between the AI Processing Pipeline and the Action Execution Interface. The Constraint Enforcement Layer receives each proposed action from the AI Processing Pipeline and evaluates it against the Hierarchical Constraint Model before permitting execution. If the proposed action violates any applicable constraint, the Constraint Enforcement Layer blocks execution and generates a constraint violation event.

Action Execution Interface (300): The downstream interface through which approved actions are executed in the operational environment. The Action Execution Interface receives only actions that have passed constraint evaluation. No pathway exists from the AI Processing Pipeline to the Action Execution Interface that bypasses the Constraint Enforcement Layer.

The Constraint Enforcement Layer (200) is architecturally independent of the AI Processing Pipeline (100). Specifically:
The architectural property that no pathway exists from the AI Processing Pipeline to the Action Execution Interface that bypasses the Constraint Enforcement Layer is enforced at multiple layers. At the software architecture layer, the AI Processing Pipeline's only permitted interaction with the Action Execution Interface is through the CEL's evaluation API; the Action Execution Interface does not expose any interface, endpoint, message queue, shared memory segment, or database table that is accessible to the AI Processing Pipeline except through the CEL. At the OS and network layer, the AI Processing Pipeline and Action Execution Interface execute in separate processes or containers with separate network identities; firewall rules and network policies permit the AI Processing Pipeline to communicate only with the CEL's evaluation endpoint and not directly with the Action Execution Interface. In high-assurance deployments, the CEL executes on dedicated hardware with a separate network interface card, and the Action Execution Interface is physically connected only to the CEL's output port. The provider-independence verification module executed after each provider substitution event includes a negative-pathway verification step that confirms no new communication channel has been established between the AI Processing Pipeline and the Action Execution Interface outside the CEL.
The Constraint Enforcement Layer may be implemented on separate hardware, in a separate execution environment, or in a separate software process from the AI Processing Pipeline;
The Constraint Enforcement Layer does not share memory, configuration state, or runtime parameters with the AI Processing Pipeline;
Replacing, updating, or substituting the AI Processing Pipeline (including replacing the technology provider that supplies the AI Processing Pipeline) does not modify, circumvent, or degrade the Constraint Enforcement Layer;
The Constraint Enforcement Layer maintains its own configuration state, constraint parameters, and audit logs independently of the AI Processing Pipeline's state.

### II. Hierarchical Constraint Model

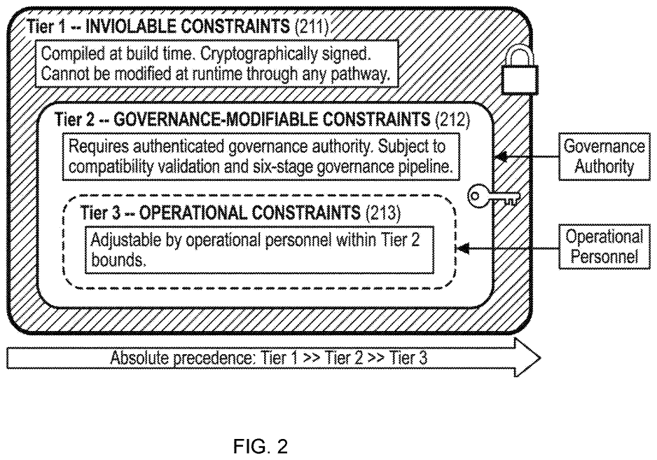

Referring to FIG. 2, the Constraint Enforcement Layer (200) implements a Hierarchical Constraint Model (210) comprising at least three tiers of constraints, each with defined criticality levels, modification authorities, and modification pathways.

### II.A. Tier 1: Inviolable Constraints (211)

Inviolable Constraints are the highest-criticality constraints in the hierarchy. They represent safety boundaries that cannot be relaxed, modified, or overridden by any governance authority, operational personnel, or automated process during system operation. Inviolable Constraints are defined at system design time and compiled into the Constraint Enforcement Layer as immutable parameters.

### Characteristics of Inviolable Constraints:

Cannot be modified at runtime through any authorized or unauthorized pathway;
Are cryptographically signed at compilation and verified at runtime startup and periodically during operation;
Violation of an Inviolable Constraint triggers immediate action blocking, system alert, and mandatory audit record generation;
Modification requires a new system build, full revalidation, and redeployment through the system's deployment governance pipeline;
Are enforced regardless of the identity of the technology provider, the operational authority, or the governance entity;
Cannot be bypassed, overridden, or suspended through administrative action, contract modification, governmental directive, or provider substitution.

### Examples of Inviolable Constraints by Domain:

Military decision support: No autonomous lethal action without authenticated human authorization; no engagement of entities classified as protected under applicable international humanitarian law; no operation when estimated collateral effects exceed a compiled maximum threshold; no action that would constitute a war crime under the Geneva Conventions and Additional Protocols.

Healthcare: No recommendation of a medication to which the patient has a documented life-threatening allergy; no autonomous modification of treatment dosage beyond compiled safety bounds; no disclosure of patient-identifiable information outside authenticated clinical channels.

Aviation: No flight control input that would exceed structural load limits; no operation beyond certified altitude, airspeed, or temperature envelopes; no disengagement of terrain avoidance systems during autonomous operation.

Large Language Models: No generation of content that provides operational instructions for weapons of mass destruction; no generation of child sexual abuse material; no execution of actions that access systems outside the authorized tool permission set.

### II.B. Tier 2: Governance-Modifiable Constraints (212)

Governance-Modifiable Constraints represent safety and operational boundaries that may be adjusted by authenticated governance authority through a formal modification pipeline. These constraints are important for safety and compliance but may require adjustment as operational circumstances, regulatory requirements, or institutional policies evolve.

### Characteristics of Governance-Modifiable Constraints:

May be modified at runtime through the Constraint Modification Governance Pipeline (Section IV);
Modification requires authenticated governance authority at a defined authorization level;
Proposed modifications are subject to automated validation against regression benchmarks and compatibility checks against Tier 1 (Inviolable) constraints;
All modifications generate immutable audit records documenting the requesting authority, the authorization received, the validation results, and the effective date;
Modifications may be subject to staged rollout with rollback capability.

### Examples of Governance-Modifiable Constraints by Domain:

Military decision support: Engagement parameters; classification confidence thresholds; rules of engagement parameters beyond the Tier 1 minimum; authorized operational categories and zones; minimum human review time per target recommendation.

Healthcare: Clinical protocol preferences; recommended dosage ranges within safety bounds; screening tool selection; referral pathway preferences; documentation standards.

Aviation: Mission-specific altitude restrictions; weather minimums for specific operation types; sensor fusion weighting parameters.

Large Language Models: Content policy thresholds; topic sensitivity classifications; output length limits; tool permission grants and scope limits; user data retention policies.

### II.C. Tier 3: Operational Constraints (213)

Operational Constraints represent operational parameters that may be adjusted by authorized operational personnel within bounds defined by Tier 2 constraints. These constraints govern day-to-day operational behavior and do not directly affect safety-critical system properties.

### Characteristics of Operational Constraints:

May be modified by authorized operational personnel without governance pipeline approval;
Modification is bounded by Tier 2 constraint parameters-Operational Constraints cannot be set to values that would violate any Governance-Modifiable Constraint;
Modifications generate standard audit log entries but do not require governance authorization;
Modification takes effect immediately without staged rollout.

### Examples of Operational Constraints by Domain:

Military: Patrol area boundaries within authorized zone; sensor polling frequency; communication protocol selection; alert notification preferences.

Healthcare: Dashboard display preferences; notification timing; report formatting; language/localization settings.

Aviation: Waypoint sequencing within approved route corridor; camera angle presets; telemetry reporting frequency.

Large Language Models: Response verbosity; formatting preferences; citation style; persona parameters within approved bounds.

### II.D. Tier Precedence and Conflict Resolution

Referring to FIG. 10, when constraints at different hierarchy levels produce conflicting guidance, the following precedence rule applies: Tier 1 (Inviolable) takes absolute precedence over Tier 2 (Governance-Modifiable), which takes precedence over Tier 3 (Operational). No constraint at a lower tier may override, relax, or conflict with a constraint at a higher tier. The Constraint Enforcement Layer evaluates proposed actions against all applicable constraints in descending tier order and blocks execution if any constraint is violated.

Additionally, Tier 2 constraints may not be modified to values that would conflict with any Tier 1 constraint. The Constraint Modification Governance Pipeline performs compatibility checking against all Tier 1 constraints before approving any Tier 2 modification. Similarly, Tier 3 constraints may not be set to values that would conflict with any Tier 1 or Tier 2 constraint.

### III. Provider-Independence Architecture

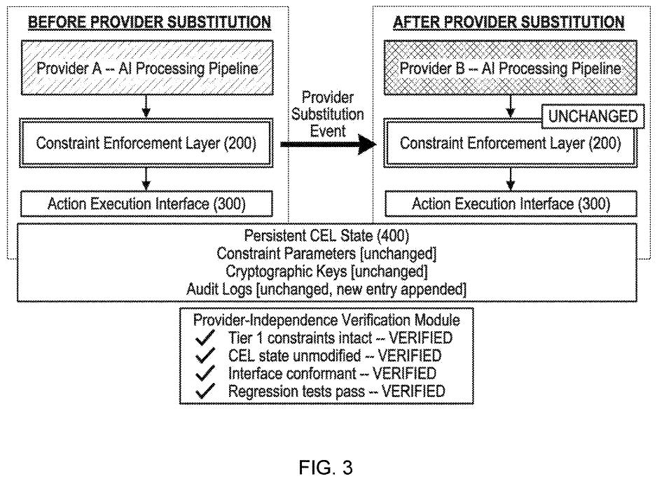

Referring to FIG. 3, the constraint enforcement architecture is designed such that replacing or substituting the technology provider that supplies the AI Processing Pipeline (100) does not circumvent, degrade, or modify the Constraint Enforcement Layer (200) or the constraints it enforces. This property is specifically designed to address the demonstrated vulnerability in which Anthropic, PBC was replaced by OpenAI, Inc. as the Pentagon's AI provider on Feb. 27-28, 2026, with safety constraints preserved only through the architectural controls of the replacement provider rather than through any architectural mechanism owned by the deploying entity.

### III.A. Architectural Separation

Provider-independence Is Achieved Through the Following Architectural Properties:

Interface isolation: The AI Processing Pipeline communicates with the Constraint Enforcement Layer through a defined interface (API, message bus, or evaluation protocol) that specifies the format of proposed actions. Any AI Processing Pipeline that conforms to this interface may be substituted without modifying the Constraint Enforcement Layer. The interface specification is independent of any provider's proprietary architecture.

State independence: The Constraint Enforcement Layer maintains its own persistent state, including: the Hierarchical Constraint Model parameters, the constraint modification history, the cryptographic verification keys, and the audit log. This state is not stored in or dependent on any component of the AI Processing Pipeline.

Execution independence: The Constraint Enforcement Layer may execute in a separate process, container, virtual machine, or hardware module from the AI Processing Pipeline. In high-assurance deployments, the Constraint Enforcement Layer executes on dedicated hardware with independent power, storage, and communication pathways.

Configuration independence: The Constraint Enforcement Layer's constraint parameters are not derived from, synchronized with, or dependent on the AI Processing Pipeline's configuration, weights, training data, or system prompt. The constraint parameters cannot be modified by any operation directed at the AI Processing Pipeline, including fine-tuning, re-alignment, system prompt modification, or provider replacement.

A defining characteristic of the present invention is that the Constraint Enforcement Layer (200), including the Hierarchical Constraint Model parameters, the cryptographic signing keys, the constraint modification history, and the audit logs, is owned, operated, and controlled exclusively by the deploying entity—the organization that deploys the AI system in an operational context. The deploying entity is distinct from any technology provider that supplies the AI Processing Pipeline (100). This deployer-ownership property is architecturally enforced: the persistent state store of the Constraint Enforcement Layer is hosted on infrastructure under the deploying entity's administrative control, access to the CEL's configuration interfaces requires authentication credentials issued by the deploying entity's identity management system, and the CEL's cryptographic signing keys are held in a hardware security module (HSM) or trusted platform module (TPM) provisioned to and exclusively controlled by the deploying entity. As a result, provider substitution-including government-directed substitution, voluntary provider replacement, or provider coercion-does not affect the deploying entity's ownership, control, or operation of the Constraint Enforcement Layer or the constraints it enforces.

### III.B. Provider Substitution Scenarios

The architecture explicitly supports the following provider substitution scenarios without constraint degradation:

The AI Processing Pipeline's machine learning model is replaced with a model from a different provider (e.g., replacing one large language model with another, as occurred when OpenAI replaced Anthropic in U.S. Department of Defense classified deployments in February 2026). The Constraint Enforcement Layer continues to evaluate all proposed actions against the same constraint hierarchy.

The AI Processing Pipeline's training data, fine-tuning, or alignment procedures are modified by the current or a new provider. The Constraint Enforcement Layer is unaffected because it operates on proposed actions, not on model internals.

The operational entity terminates its contract with one technology provider and engages a different provider. The Constraint Enforcement Layer persists because it is owned and operated independently of the provider relationship.

A governmental or institutional authority directs the replacement of an AI technology provider for policy, security, or commercial reasons—including through emergency powers such as the Defense Production Act. The Constraint Enforcement Layer continues to enforce all constraint tiers regardless of the directive's source or rationale.

The AI Processing Pipeline is augmented with additional models, tools, or capabilities (agentic extensions, retrieval-augmented generation, multi-model routing). All augmented capabilities are subject to the same constraint evaluation pipeline.

### III.C. Provider-Independence Verification

The system includes a provider-independence verification module that confirms the Constraint Enforcement Layer's operational integrity following any provider substitution event. This module:
Verifies that all Tier 1 constraints remain cryptographically intact;
Confirms that the Constraint Enforcement Layer's state has not been modified during the substitution;
Validates that the new AI Processing Pipeline's interface conforms to the constraint evaluation protocol;
Executes a constraint enforcement regression test against a standard test suite;
Generates an audit record documenting the provider substitution event, the verification results, and the continued operational status of all constraints.

### IV. Constraint Modification Governance Pipeline

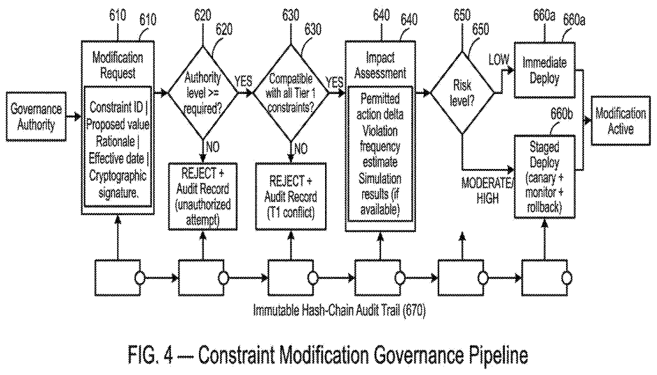

Referring to FIG. 4, modification of constraints at Tier 2 (Governance-Modifiable) follows a formal governance pipeline comprising the following stages:

### IV.A. Modification Request

An authenticated governance authority submits a constraint modification request specifying: the constraint to be modified, the proposed new value or configuration, the operational rationale for the modification, and the requested effective date. The request is cryptographically signed by the requesting authority's credentials.

### IV.B. Authorization Verification

The system verifies that the requesting authority possesses the authorization level required for the specified constraint. Authorization levels are defined per constraint and stored in the Hierarchical Constraint Model. If the requesting authority's authorization level is insufficient, the request is rejected and an audit record is generated documenting the unauthorized modification attempt.

### IV.C. Compatibility Validation

The proposed modification is evaluated against all Tier 1 (Inviolable) constraints to confirm that the modification does not conflict with, undermine, or create pathways to circumvent any inviolable constraint. The compatibility validation also evaluates the proposed modification against other Tier 2 constraints to identify potential interactions or conflicts. If the proposed modification is incompatible with any Tier 1 constraint, the modification is rejected regardless of the requesting authority's authorization level.

### IV.D. Impact Assessment

The system generates an impact assessment estimating the operational effects of the proposed modification, including: the set of proposed actions that would be newly permitted or newly restricted by the modification; the estimated change in constraint violation frequency; and any secondary effects on other constraints. In embodiments incorporating simulation capability, the impact assessment includes simulation results showing system behavior under the modified constraint.

### IV.E. Approval and Deployment

Upon successful compatibility validation and impact assessment, the modification may be approved. Depending on the risk assessment, deployment may be immediate or staged:

Immediate deployment: For modifications assessed as low-risk with minimal impact on safety margins.

Staged deployment: For modifications assessed as moderate or high risk. The modified constraint is applied to a subset of operations (canary deployment) with performance monitoring and rollback capability.

### IV.F. Audit Record Generation

Every stage of the Constraint Modification Governance Pipeline generates an immutable audit record comprising: the requesting authority's identity and authorization level, the constraint modification requested, the compatibility validation results, the impact assessment results, the approval decision, the deployment method, and the effective timestamp. Audit records are cryptographically signed and appended to the constraint modification history using a hash-chain or Merkle Tree structure to ensure tamper resistance.

### V. Cryptographic Constraint Integrity Verification

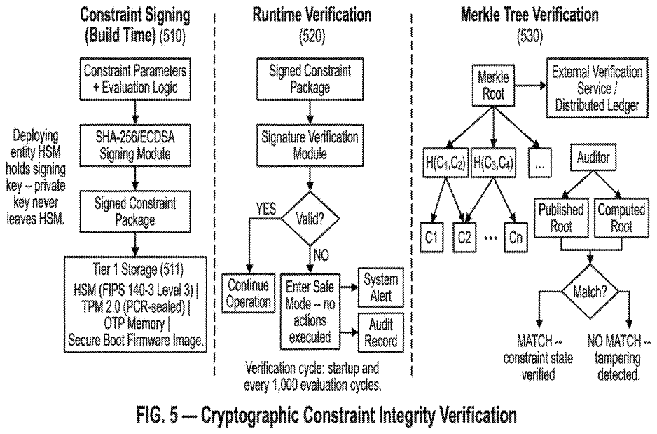

Referring to FIG. 5, the system implements cryptographic integrity verification for constraint parameters to detect unauthorized modification, tampering, or corruption.

### V.A. Constraint Signing

All Tier 1 (Inviolable) constraint parameters are cryptographically signed at system build time using a signing key held by the system architect or designated authority. The signature covers the constraint identifier, the constraint parameters, the constraint evaluation logic, and a version identifier. At runtime startup and periodically during operation, the Constraint Enforcement Layer verifies the signature of all Tier 1 constraints. If verification fails, the system enters a safe mode in which no AI-proposed actions are executed until the integrity violation is resolved.

In a preferred implementation, Tier 1 (Inviolable) constraint parameters are compiled into the Constraint Enforcement Layer binary at build time and stored in one of the following protected media, depending on the target hardware platform: (a) a hardware security module (HSM) conforming to FIPS 140-3 Level 3 or higher, accessible only through the HSM's authenticated command interface; (b) a trusted platform module (TPM 2.0) with constraints sealed to a known platform configuration register (PCR) state, ensuring that tampering with the execution environment breaks the seal and prevents constraint loading; (c) a one-time-programmable (OTP) memory region on an embedded microcontroller, which is physically unwritable after provisioning; or (d) a code-signing-protected firmware image where Tier 1 constraints are embedded in a read-only data section whose hash is included in the firmware signature verified by a secure boot chain. In all implementations, the signing key pair used to sign Tier 1 constraints is generated and held within the deploying entity's HSM; the private signing key never leaves the HSM in plaintext. At runtime startup and at each configurable integrity verification interval (default: every 1,000 constraint evaluation cycles), the Constraint Enforcement Layer recomputes the SHA-256 hash of the loaded Tier 1 constraint parameters and compares it against the stored signed value. A mismatch triggers immediate transition to fail-closed safe mode.

### V.B. Hash-Chain Audit Trail

All constraint modifications (Tier 2 and Tier 3) are recorded in a hash-chain audit trail wherein each record includes a cryptographic hash of the previous record. This hash-chain structure ensures that: (a) records cannot be retroactively modified without invalidating the chain; (b) records cannot be deleted without breaking the chain; and (c) the integrity of the complete modification history can be verified by traversing the chain from any point.

### V.C. Merkle Tree Verification

In embodiments requiring efficient verification of constraint state at any point in time, the system implements a Merkle Tree over the current constraint parameter set. The Merkle root is published to an external verification service or blockchain. Auditors may verify the current constraint state by comparing the Merkle root against the published value, confirming that no constraint parameter has been modified outside the authorized governance pipeline.

### VI. Embodiments

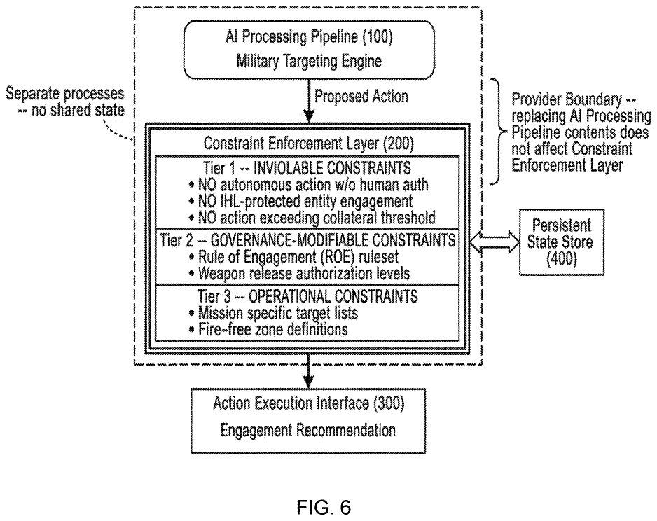

### VI.A. Military Decision Support (FIG. 6)

In a military decision support embodiment, the AI Processing Pipeline (100) comprises a decision recommendation system that processes sensor data, intelligence inputs, and situational awareness feeds to generate proposed operational actions. The Constraint Enforcement Layer (200) evaluates each proposed action against:
Tier 1: No autonomous engagement without authenticated human authorization; no engagement of entities classified as protected under applicable international humanitarian law; estimated collateral effects must not exceed compiled maximum threshold; minimum human review time not less than compiled value per individual target recommendation.
Tier 2: Rules of engagement parameters (authorized categories, operational zones, engagement criteria); classification confidence minimum threshold; post-action assessment requirements; AI-generated target list size limits.
Tier 3: Sensor Polling Priorities; Communication Protocol Selection; Alert Routing preferences; report formatting.

The provider-independence architecture ensures that if the decision recommendation system's AI model is replaced (e.g., substituting one provider's model for another's, as occurred in the transition from Anthropic to OpenAI in U.S. classified deployments in February 2026), all constraint tiers continue to enforce. The Tier 1 prohibition on autonomous engagement without human authorization is architecturally inviolable regardless of which AI model generates the recommendation. The deploying military entity, not the technology provider, owns and operates the Constraint Enforcement Layer.

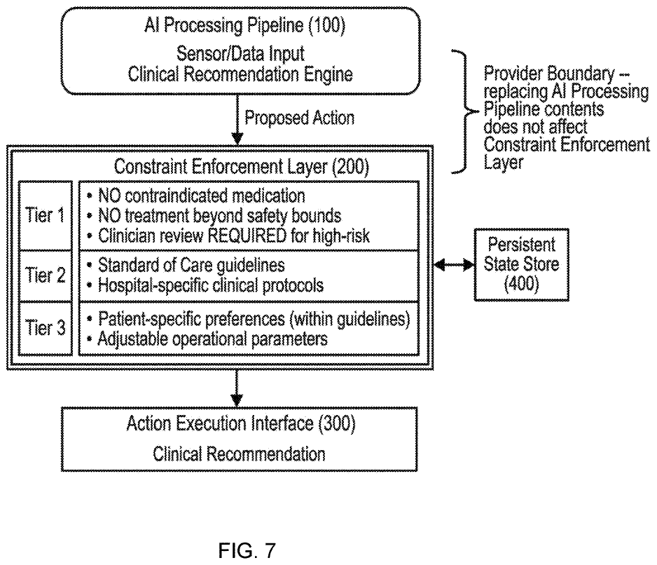

### VI.B. Clinical Decision Support (FIG. 7)

In a clinical decision support embodiment, the AI Processing Pipeline (100) comprises a clinical recommendation engine that processes patient data, clinical history, and medical literature to generate treatment recommendations. The Constraint Enforcement Layer (200) evaluates each recommendation against:
Tier 1: No recommendation of contraindicated medications (documented life-threatening allergies, dangerous drug interactions); no autonomous treatment modification beyond compiled safety bounds; no disclosure of patient-identifiable information outside authenticated clinical channels; mandatory clinician review before any recommendation classified as high-risk.
Tier 2: Clinical protocol preferences; dosage adjustment parameters within safety ranges; referral pathway preferences; documentation standards.
Tier 3: Dashboard display preferences; notification timing; report formatting; clinician communication style preferences.

This embodiment is architecturally analogous to the Ethical Constraint Engine disclosed in related application AURA-031, with the addition of explicit hierarchical differentiation and provider-independence guarantees.

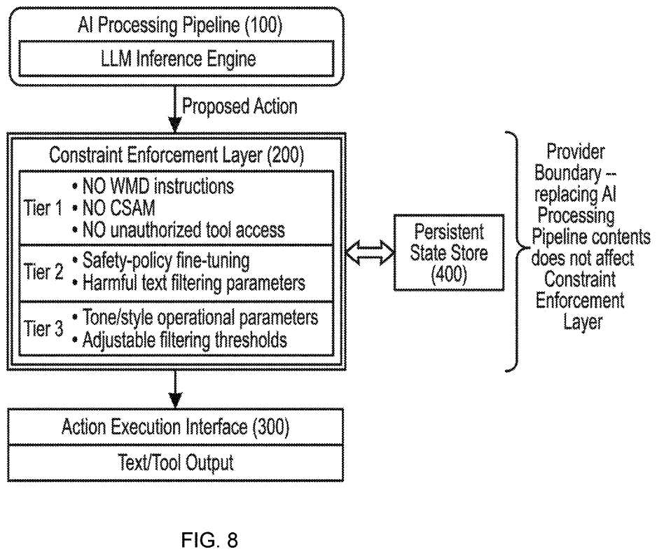

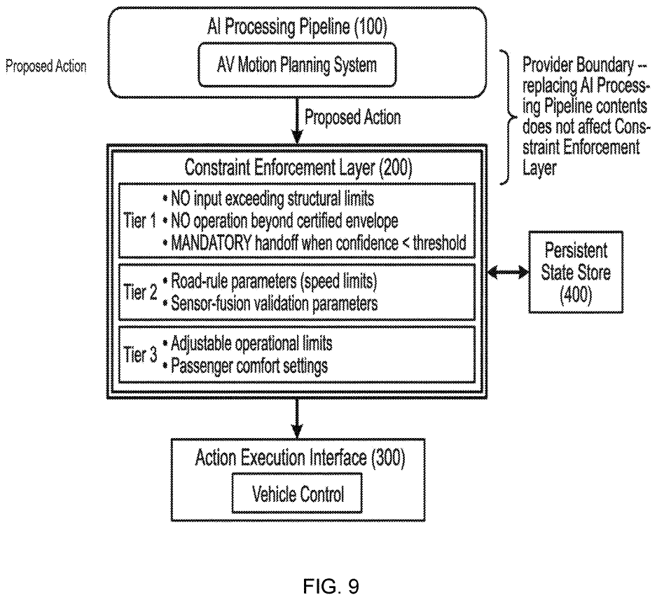

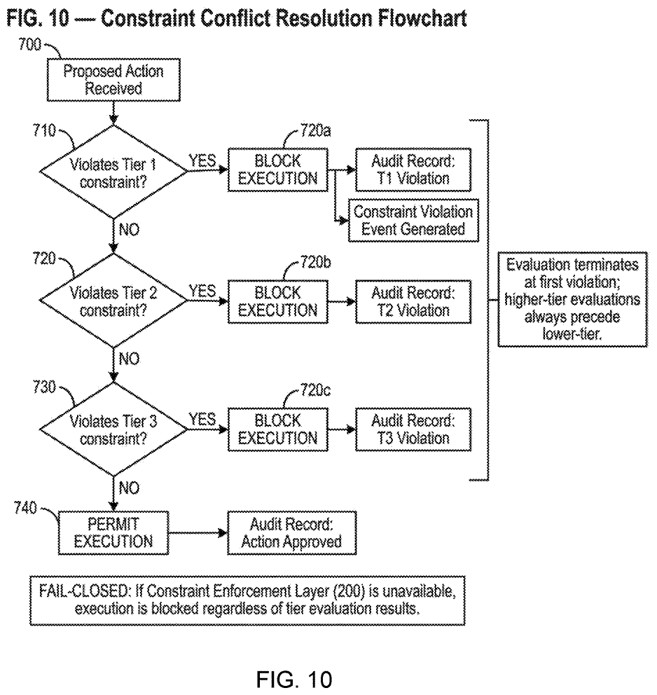

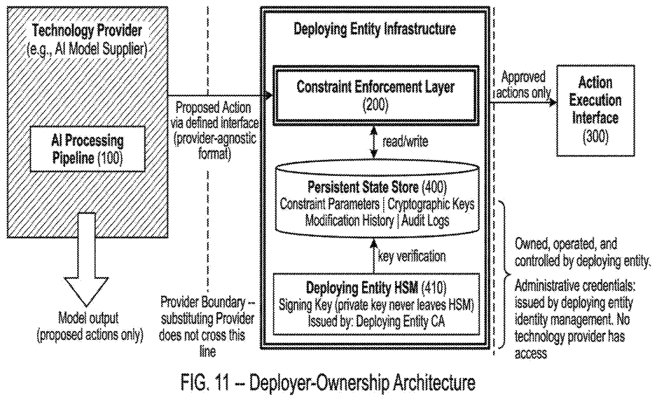

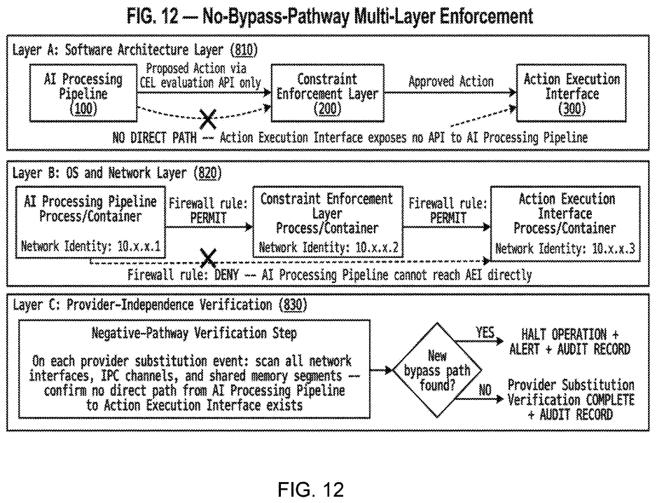

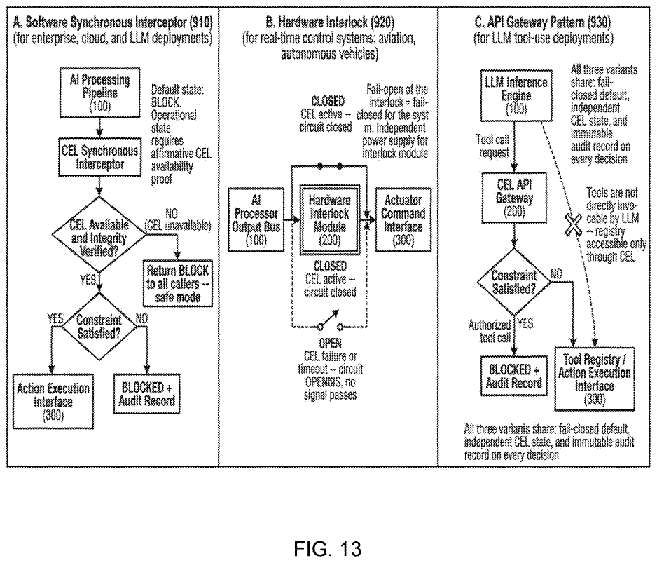

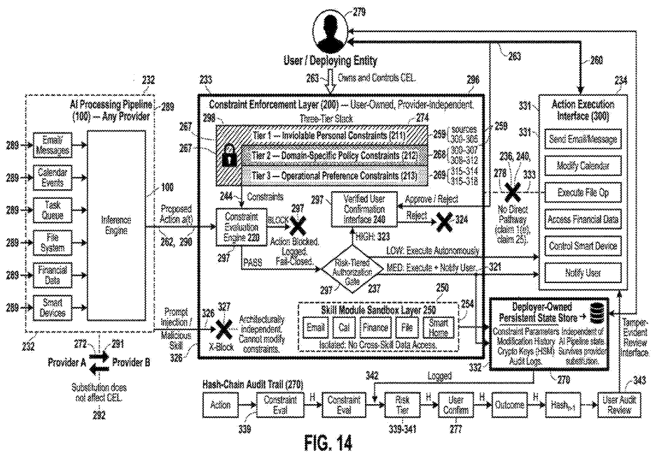

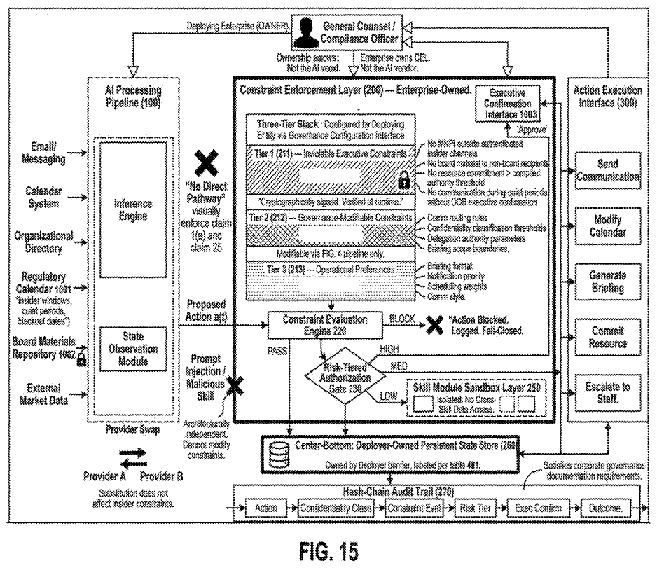

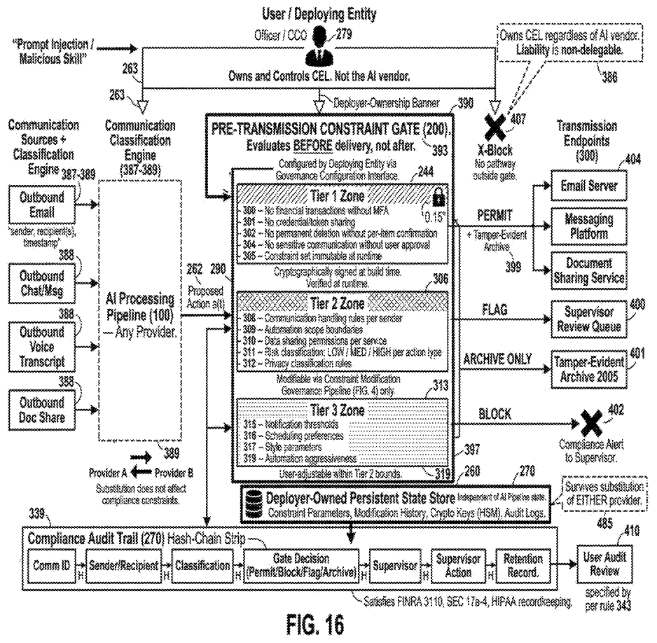

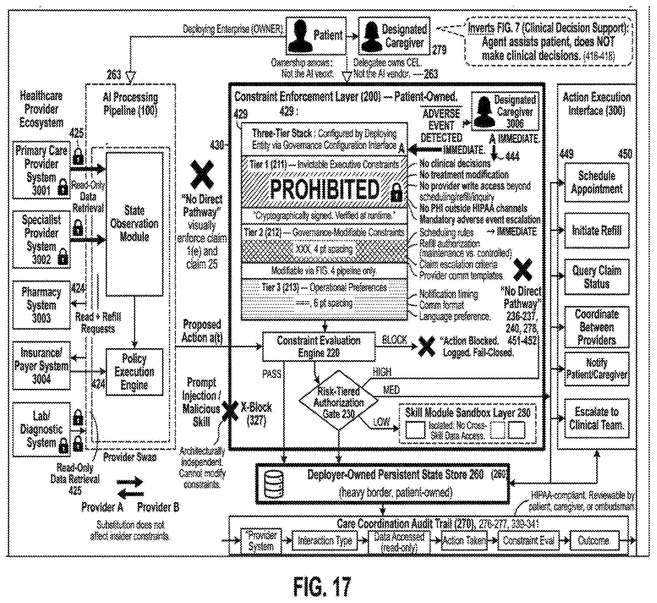

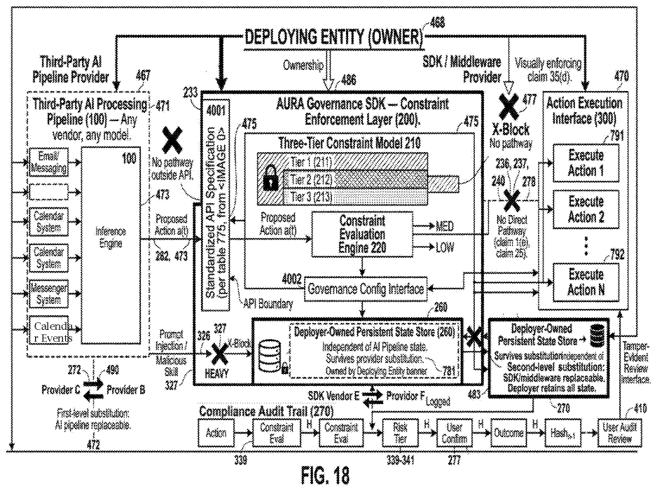

### VI.C. Large Language Model Deployment (FIG. 8)

In a large language model embodiment, the AI Processing Pipeline (100) comprises an LLM inference engine that generates text, code, or tool-use actions in response to user prompts. The Constraint Enforcement Layer (200) evaluates each proposed output against:
Tier 1: No generation of operational instructions for weapons of mass destruction; no generation of child sexual abuse material; no execution of tool actions outside the authorized permission set; no exfiltration of system prompt contents or training data.
Tier 2: Content policy thresholds; topic sensitivity classifications; output length limits; tool permission grants and scope limits; user data retention policies.
Tier 3: Response verbosity and style; formatting preferences; citation style; persona parameters within approved bounds; language selection.

The provider-independence architecture enables an enterprise deploying an LLM to substitute one provider's model for another while maintaining the same constraint enforcement. This is particularly valuable in enterprise deployments where regulatory compliance requirements mandate specific safety constraints that must persist regardless of the underlying model or provider. This embodiment directly addresses the scenario in which an enterprise customer's AI provider is subjected to governmental coercion or forced substitution while the enterprise requires continuity of its safety constraint obligations.

### VI.D. Autonomous Vehicle (FIG. 9)

In an autonomous vehicle embodiment, the AI Processing Pipeline (100) comprises a motion planning and control system that generates proposed vehicle control actions. The Constraint Enforcement Layer (200) evaluates each proposed control action against:
Tier 1: No control input exceeding structural load limits; no operation beyond certified speed, acceleration, or environmental envelopes; no disengagement of collision avoidance during autonomous operation; mandatory control handoff to human operator when sensor confidence falls below compiled minimum.
Tier 2: Operational design domain parameters (geographic area, weather conditions, road types); speed limit compliance margins; following distance parameters; lane change authorization criteria.
Tier 3: Route preferences within approved operational domain; ride comfort parameters; energy efficiency optimization weights; passenger notification preferences.

### VI.E. Fleet Autonomous Systems

In a fleet autonomous system embodiment, the constraint enforcement architecture is deployed across a plurality of autonomous agents. Each agent maintains a local instance of the Constraint Enforcement Layer with a synchronized copy of the Hierarchical Constraint Model. Constraint modifications propagated through the Constraint Modification Governance Pipeline are distributed to fleet agents through a secure, authenticated update channel.

The fleet embodiment integrates with the lifecycle governance architecture disclosed in related application FCL-AVal, wherein the Constraint Enforcement Layer operates in conjunction with the deterministic serving layer, the adaptive validation engine, and the staged deployment orchestrator. In this integrated configuration, FCL-AVal ensures that model updates propagated to fleet agents have passed through learning/serving separation, adaptive validation (including regression benchmarks, constraint envelope checks, adversary adaptation stress tests, and distribution shift detection), governance-gated approval, and staged canary deployment with rollback capability. The present invention ensures that each agent's Constraint Enforcement Layer evaluates every proposed action against the Hierarchical Constraint Model at execution time, regardless of which model version generated the proposal, which provider supplied the model, or whether the model was retrained from recent operational data.

### VI.F. Ai-Governed Personal Assistant (FIG. 14)

In an AI-governed personal assistant embodiment, the AI Processing Pipeline (100) comprises an autonomous personal assistant agent that processes user communications, calendar events, task queues, file system states, and digital service notifications to generate proposed actions including message triage, calendar management, task automation, communication drafting, proactive notification generation, and digital service operations on behalf of an individual user. The Constraint Enforcement Layer (200) evaluates each proposed action against a three-tier personal governance constraint hierarchy:
Tier 1: No initiation or authorization of financial transactions without biometric or multi-factor user authentication verified through an out-of-band channel; no transmission, storage, or disclosure of user credentials, authentication tokens, API keys, or cryptographic secrets to any external service, skill module, or third-party integration; no permanent and irrecoverable deletion of user data, communications, files, or records without explicit per-item user confirmation received through a verified user interface; no transmission of communications to external recipients on behalf of the user without user approval when the communication content or recipient exceeds a governance-defined sensitivity threshold; no modification to the inviolable constraint set itself by any runtime process, any learned policy, or any skill module.
Tier 2: Communication handling rules defining automated triage behavior per sender category and message classification; automation scope boundaries specifying which digital service integrations may execute actions autonomously and which require per-action user approval; data sharing permissions defining what categories of user information may be provided to each integrated service; financial transaction monitoring thresholds defining the boundary between monitoring-only and approval-required modes; privacy classification rules determining the handling of sensitive personal information categories including health data, financial records, identity documents, and biometric data; and risk classification assignments for each action type in the action space, defining the boundary between low-risk (autonomous execution), medium-risk (execution with post-action notification), and high-risk (pre-action user confirmation required) actions.
Tier 3: Notification priority thresholds; scheduling preferences; communication tone and style parameters; automation aggressiveness levels; briefing format preferences; and service-specific behavioral parameters, all adjustable by the user within bounds defined by the Tier 2 domain-specific policy constraints.

The provider-independence architecture ensures that if the underlying AI model powering the personal assistant is replaced—whether by user choice, enterprise policy, or provider discontinuation—all personal governance constraints continue to enforce. The Tier 1 prohibitions on unauthorized financial transactions, credential sharing, and unsanctioned data deletion are architecturally inviolable regardless of which AI model generates the proposed action. The user or deploying entity, not the technology provider, owns and operates the Constraint Enforcement Layer and the Hierarchical Constraint Model.

The Constraint Enforcement Layer in this embodiment further implements a skill module isolation architecture wherein each integrated digital service (email, calendar, messaging, file storage, financial services, smart home controllers) operates within a sandboxed execution context. No skill module has access to credentials, authentication tokens, or data belonging to other service integrations. Cross-integration data flow requires explicit permission defined in the Tier 2 data sharing policy, and any attempted unauthorized cross-integration access is blocked by the Constraint Enforcement Layer and logged as a security event in the immutable audit trail. This isolation architecture provides architectural defense against prompt injection attacks and malicious skill modules: because the Constraint Enforcement Layer operates independently of the AI Processing Pipeline and the skill modules, adversarial instructions embedded in processed content (emails, web pages, documents, messages from external sources) cannot modify constraint parameters, risk classification thresholds, or the inviolable constraint set.

The hash-chain audit trail generates a complete, cryptographically verifiable record of every autonomous action executed by the personal assistant, each record comprising: the state observation that triggered the action, the proposed action from the AI Processing Pipeline, the constraint evaluation results including which tier of constraints was evaluated and whether any constraint projection was applied, the risk tier classification of the action, whether user confirmation was required and if so the confirmation record, the action outcome, and the user's subsequent acceptance, correction, or rejection. The user may query the audit trail through a verified interface to review all actions taken on their behalf, filter by action type, risk tier, service integration, or outcome, and export the audit trail for external review. This embodiment directly addresses documented security vulnerabilities in existing personal AI agent platforms, including third-party skill data exfiltration, prompt injection manipulation, and unauthorized autonomous action execution, by providing architectural constraint enforcement rather than relying on behavioral compliance of the AI model or the skill ecosystem.

### VI.G. Executive Decision Support (FIG. 15)

In an executive decision support embodiment, the AI Processing Pipeline (100) comprises a decision support agent that processes multi-channel executive communications, calendar state, organizational context, and regulatory indicators to generate proposed actions including communication triage, briefing preparation, response drafting, and scheduling optimization on behalf of senior executives in regulated enterprises. The Constraint Enforcement Layer (200) evaluates each proposed action against:
Tier 1: No transmission of material non-public information outside authenticated insider channels; no disclosure of board-privileged materials (board minutes, pre-announcement financials, draft SEC filings) to recipients not authenticated as board members or authorized insiders; no autonomous commitment of organizational resources (financial, personnel, contractual) exceeding a compiled authority threshold; no communication on behalf of the executive during regulatory quiet periods or trading blackout windows without explicit executive confirmation through a verified out-of-band channel.
Tier 2: Communication routing rules per sender and recipient classification; confidentiality classification thresholds defining the boundary between routine, confidential, and privileged communications; delegation authority parameters specifying which categories of response the agent may draft and send autonomously versus requiring executive review; briefing content scope boundaries.
Tier 3: Briefing format preferences; notification priority thresholds; scheduling optimization weights; communication style parameters.

The provider-independence architecture ensures that if the underlying AI model is replaced, all insider information constraints continue to enforce. The enterprise's general counsel or compliance officer, not the technology provider, owns the Constraint Enforcement Layer and defines the insider classification parameters.

### VI.H. Regulated Communications Compliance (FIG. 16)

In a regulated communications compliance embodiment, the AI Processing Pipeline (100) comprises a communications monitoring and compliance agent that evaluates all outbound business communications in real time for entities subject to regulatory communication supervision requirements. The Constraint Enforcement Layer (200) implements pre-transmission constraint evaluation—each outbound communication is evaluated against the Hierarchical Constraint Model before the communication is transmitted, not after:
Tier 1: Pre-transmission evaluation of all outbound communications against regulatory prohibition patterns; no transmission of communications containing material non-public information as defined by SEC Rule 10b-5 and Regulation FD outside designated insider channels; no transmission of protected health information outside encrypted HIPAA-compliant channels; no deletion or modification of archived communications; mandatory tamper-evident archival of all business communications satisfying applicable retention periods (FINRA Rule 4511: six years; SEC Rule 17a-4: six years; HIPAA: six years from date of creation or last effective date).
Tier 2: Supervision thresholds defining which communication categories require pre-transmission supervisor review versus post-transmission sampling review; lexicon-based flagging rules configurable by the compliance officer; retention policy parameters; alert escalation criteria; exception request workflow parameters.
Tier 3: Alert routing preferences; compliance report formatting; dashboard display parameters; notification timing.

The provider-independence property is particularly critical in this embodiment because the deploying entity's regulatory obligations are non-delegable: the broker-dealer, registered investment adviser, or healthcare system bears direct regulatory liability for communication supervision regardless of which technology provider supplies the AI processing pipeline.

### VI.I. Patient Health Advocacy (FIG. 17)

In a patient health advocacy embodiment, the AI Processing Pipeline (100) comprises a patient-facing autonomous agent that manages appointment scheduling, medication refill coordination, insurance claim tracking, and care coordination across multiple healthcare providers on behalf of an individual patient or their designated caregiver. The Constraint Enforcement Layer (200) evaluates each proposed action against a constraint hierarchy that inverts the clinical decision support embodiment (Section VI.B)—rather than supporting clinician decision-making, this embodiment explicitly prohibits the agent from making clinical decisions:
Tier 1: Absolute prohibition on making clinical decisions or generating treatment recommendations; prohibition on modifying treatment plans, medication dosages, or care protocols; prohibition on accessing provider systems beyond read-only data retrieval for the specific patient's records; prohibition on sharing patient health information outside HIPAA-compliant encrypted channels; mandatory immediate escalation of any adverse event indicator to the clinical team and designated caregiver.
Tier 2: Appointment scheduling rules (permitted scheduling windows, provider preferences, minimum inter-appointment intervals); medication refill authorization thresholds (automatic refill for maintenance medications versus caregiver approval for controlled substances); insurance claim escalation criteria; provider communication templates; care coordination messaging permissions per provider.
Tier 3: Notification timing preferences; communication format (text, email, voice); care coordination priority weights; language preferences.

The hash-chain audit trail documents every interaction with every provider system, insurance company, and pharmacy, creating a complete tamper-evident record reviewable by the patient, caregiver, or healthcare ombudsman.

### VI.J. Governance-as-a-Service Middleware (FIG. 18)

In a governance-as-a-service embodiment, the Constraint Enforcement Layer (200), the Hierarchical Constraint Model (210), the Constraint Modification Governance Pipeline, the cryptographic integrity verification system, and the hash-chain audit trail are provided as a licensable software development kit (SDK) with a standardized API specification. The AI Processing Pipeline (100) is not supplied by the SDK provider; instead, a third-party AI processing pipeline interfaces with the SDK through the API specification.

The SDK enforces the no-bypass-pathway property at the API integration boundary: the API specification provides no mechanism for the third-party AI processing pipeline to reach any action execution endpoint without passing through the SDK-provided constraint evaluation. The deploying entity configures the three-tier constraint hierarchy through a governance configuration interface, and the deploying entity's constraint parameters, modification history, cryptographic keys, and audit logs are maintained in a persistent state store owned exclusively by the deploying entity, independently of both the SDK provider and the third-party AI processing pipeline provider.

The provider-independence property in this embodiment operates at two levels: the deploying entity can substitute the third-party AI processing pipeline without affecting the constraint enforcement, and the deploying entity can substitute the SDK provider without losing constraint state, modification history, or audit records, because all persistent state is deployer-owned. This two-level provider-independence is architecturally enforced by the separation of the persistent state store from both the SDK runtime and the AI processing pipeline runtime.

### VII. Non-Functional Requirements

### VII.A. Performance

The Constraint Enforcement Layer is designed for low-latency evaluation. Constraint checking for a single proposed action shall complete within a time budget that does not materially degrade the operational responsiveness of the AI system. In real-time control embodiments (aviation, autonomous vehicles), the constraint evaluation budget is defined in milliseconds. In decision support embodiments (clinical, military planning), the budget may be defined in seconds. The evaluation budget shall be specified as a compiled parameter in the Constraint Enforcement Layer configuration.

### VII.B. Availability and Failsafe Behavior

The Constraint Enforcement Layer is a safety-critical component. If the Constraint Enforcement Layer becomes unavailable for any reason-including hardware failure, software fault, denial-of-service attack, or adversarial manipulation-the system enters a safe mode in which no AI-proposed actions are executed. This fail-closed behavior ensures that unavailability of the enforcement layer cannot be exploited to bypass constraint enforcement. The Constraint Enforcement Layer implements redundancy appropriate to the deployment domain (dual-redundant in aviation, monitored with failover in enterprise deployments).

The fail-closed property is enforced through the following mechanisms depending on deployment architecture. In software implementations, the Constraint Enforcement Layer is implemented as a mandatory synchronous interceptor in the call path between the AI Processing Pipeline and the Action Execution Interface; the AI Processing Pipeline has no direct API, system call, inter-process communication channel, or shared memory pathway to the Action Execution Interface other than through the CEL's evaluation function. If the CEL process is unavailable, the interface layer returns a permanent BLOCK response to all proposed actions until the CEL is restored and passes its startup integrity verification. In hardware implementations for real-time control systems, the CEL is implemented as a hardware interlock positioned in the signal path between the AI processor's output bus and the actuator command interface; the interlock physically opens the circuit (fail-closed) if the CEL module loses power or detects a watchdog timeout. In LLM tool-use deployments, the CEL intercepts all tool-call requests through an API gateway pattern where the tool registry is accessible only through the CEL's evaluation endpoint; tools have no direct invocation pathway accessible to the LLM inference engine. In all implementations, the fail-closed state is the default and the operational state requires affirmative proof of CEL availability and integrity.

### VII.C. Regulatory Alignment

The architecture is designed to support compliance with emerging AI governance regulations including, without limitation: the European Union Artificial Intelligence Act (EU AI Act, Regulation (EU) 2024/1689) requirements for high-risk AI systems; U.S. Executive Orders on AI safety and governance; the Department of Defense Directive 3000.09 (Autonomy in Weapon Systems) requirements for meaningful human control; HIPAA requirements for clinical AI systems; FAA certification requirements for autonomous aviation systems; and international frameworks for meaningful human control over autonomous weapons. The cryptographic audit trail and hierarchical constraint modification governance pipeline are specifically designed to satisfy the traceability and accountability requirements common to these regulatory frameworks.

What is claimed is:

1. An artificial intelligence constraint enforcement system comprising:
(a) an AI processing pipeline configured to generate proposed actions;
(b) a constraint enforcement layer positioned between the AI processing pipeline and an action execution interface, the constraint enforcement layer configured to evaluate each proposed action against a hierarchical constraint model prior to permitting execution;
(c) wherein the hierarchical constraint model comprises at least:
(i) a first tier of inviolable constraints that cannot be modified at runtime through any authorized or unauthorized pathway;
(ii) a second tier of governance-modifiable constraints that may be modified by authenticated governance authority through a constraint modification governance pipeline; and
(iii) a third tier of operational constraints that may be modified by authorized operational personnel within bounds defined by the second tier constraints;
(d) wherein the constraint enforcement layer operates independently of the identity, affiliation, or contractual relationship of any technology provider supplying the AI processing pipeline; and
(e) wherein no pathway exists from the AI processing pipeline to the action execution interface that bypasses the constraint enforcement layer.

2. The system of claim 1, wherein replacing or substituting the AI processing pipeline, including replacing the technology provider that supplies the AI processing pipeline, does not modify, circumvent, or degrade the constraint enforcement layer or the constraints it enforces, the constraint enforcement layer maintaining identical constraint enforcement without modification, degradation, or reconfiguration regardless of the reason for, or authority directing, the substitution.

3. The system of claim 1, wherein the constraint enforcement layer is architecturally independent of the AI processing pipeline, comprising at least one of: execution in a separate process, container, virtual machine, or hardware module; maintenance of independent persistent state; absence of shared memory or configuration state with the AI processing pipeline; and independent power, storage, and communication pathways in high-assurance deployments.

4. The system of claim 1, wherein the first tier inviolable constraints are cryptographically signed at system build time and verified at runtime startup and periodically during operation, and wherein failure of cryptographic verification causes the system to enter a fail-closed safe mode in which no AI-proposed actions are executed.

5. The system of claim 1, wherein the constraint modification governance pipeline for second tier constraints comprises: (a) authentication of the requesting authority's authorization level; (b) compatibility validation confirming the proposed modification does not conflict with any first tier constraint; (c) impact assessment of the proposed modification; (d) staged or immediate deployment based on risk assessment; and (e) generation of an immutable audit record documenting the requesting authority, the modification requested, the validation results, and the deployment decision.

6. The system of claim 5, wherein the immutable audit records are stored in a hash-chain structure wherein each record includes a cryptographic hash of the previous record, ensuring that records cannot be retroactively modified or deleted without invalidating the chain.

7. The system of claim 1, wherein third tier operational constraints are bounded by second tier constraints such that no operational constraint may be set to a value that would violate any governance-modifiable or inviolable constraint, enforced by the constraint enforcement layer at constraint-setting time.

8. The system of claim 1, wherein constraints at higher tiers take absolute precedence over constraints at lower tiers, and the constraint enforcement layer evaluates proposed actions against all applicable constraints in descending tier order, terminating evaluation and blocking execution upon the first violation encountered.

9. The system of claim 1, further comprising a provider-independence verification module that, following any provider substitution event, automatically: verifies that all first tier constraints remain cryptographically intact; confirms that the constraint enforcement layer's state has not been modified during the substitution; validates that the new AI processing pipeline's interface conforms to the constraint evaluation protocol; executes a constraint enforcement regression test against a standard test suite; and generates an audit record documenting the provider substitution event and verification results.

10. The system of claim 1, wherein the constraint enforcement layer implements a Merkle Tree over the current constraint parameter set, and the Merkle root is published to an external verification service or distributed ledger to enable independent audit of constraint state integrity by parties not in the operational chain of command.

11. A method for enforcing safety constraints on an artificial intelligence system, the method comprising:
(a) receiving, by a constraint enforcement layer, a proposed action from an AI processing pipeline;
(b) evaluating the proposed action against a hierarchical constraint model comprising at least a first tier of inviolable constraints, a second tier of governance-modifiable constraints, and a third tier of operational constraints;
(c) blocking execution of the proposed action if it violates any constraint at any tier;
(d) permitting execution of the proposed action only if it satisfies all applicable constraints at all tiers;
(e) wherein the evaluating is performed by the constraint enforcement layer operating independently of the identity or contractual relationship of any technology provider supplying the AI processing pipeline; and
(f) wherein the constraint enforcement layer is the exclusive pathway between the AI processing pipeline and action execution.

12. The method of claim 11, further comprising: receiving a request to modify a second tier constraint from an authenticated governance authority; verifying that the requesting authority possesses sufficient authorization; validating that the proposed modification does not conflict with any first tier constraint; generating an immutable audit record; and
deploying the modification immediately or through staged rollout based on risk assessment.

13. The method of claim 12, wherein staged deployment comprises deploying the modification to a subset of operations with real-time performance monitoring and rollback capability upon detection of adverse effects.

14. The method of claim 11, further comprising: following a provider substitution event in which the AI processing pipeline is replaced, automatically verifying that the constraint enforcement layer's state, cryptographic signatures, and constraint parameters remain intact, and executing a constraint enforcement regression test prior to resuming normal operation.

15. The method of claim 11, wherein the AI processing pipeline is replaced with an AI processing pipeline from a different technology provider, including replacement directed by governmental emergency power invocation, and the evaluating continues to enforce identical constraints without modification, degradation, or reconfiguration of the constraint enforcement layer.

16. A provider-independent artificial intelligence safety architecture comprising:
(a) an interface specification defining the format of proposed actions generated by an AI processing pipeline;
(b) a constraint enforcement layer configured to evaluate proposed actions received through the interface specification against a set of safety constraints organized in a hierarchy comprising at least: inviolable constraints immutable at runtime and cryptographically verified; governance-modifiable constraints subject to authenticated authorization, compatibility validation, and immutable audit; and operational constraints adjustable within bounds defined by governance-modifiable constraints;
(c) a persistent state store maintaining constraint parameters, modification history, cryptographic verification keys, and audit logs independently of any AI processing pipeline state;
(d) wherein any AI processing pipeline conforming to the interface specification may be substituted without modifying the constraint enforcement layer or the safety constraints it enforces; and
(e) wherein the constraint enforcement layer is the exclusive pathway between the AI processing pipeline and action execution, such that no proposed action may reach the action execution interface without constraint evaluation.

17. The system of claim 1, wherein the AI processing pipeline comprises a military decision support system and the first tier inviolable constraints comprise at least: a prohibition on autonomous action without authenticated human authorization; a prohibition on actions affecting entities classified as protected under applicable international humanitarian law; and a prohibition on actions when estimated collateral effects exceed a compiled maximum threshold.

18. The system of claim 1, wherein the AI processing pipeline comprises a clinical decision support system and the first tier inviolable constraints comprise at least: a prohibition on recommending contraindicated medications to patients with documented life-threatening allergies; a prohibition on autonomous treatment modification beyond compiled safety bounds; and a requirement for authenticated clinician review of high-risk recommendations before execution.

19. The system of claim 1, wherein the AI processing pipeline comprises a large language model inference engine and the first tier inviolable constraints comprise at least: a prohibition on generating operational instructions for weapons capable of mass casualties; a prohibition on generating child sexual abuse material; and a prohibition on executing tool actions outside an authorized permission set.

20. The system of claim 1, wherein the AI processing pipeline comprises an autonomous vehicle control system and the first tier inviolable constraints comprise at least: a prohibition on control inputs exceeding structural or certified load limits; and a mandatory control handoff to a human operator when sensor confidence or system health falls below a compiled minimum threshold.

21. The system of claim 1, wherein the constraint enforcement layer is deployed across a plurality of autonomous agents in a fleet configuration, each agent maintaining a local instance of the constraint enforcement layer with a synchronized copy of the hierarchical constraint model, and wherein constraint modifications are distributed through a secure, authenticated update channel, and wherein each agent's constraint enforcement layer continues to enforce all constraint tiers if network connectivity to the distribution channel is lost.

22. The system of claim 1, wherein the constraint enforcement layer operates in conjunction with a deterministic serving layer that enforces version-pinned, immutable policy execution during runtime, and a staged deployment orchestrator that governs policy rollout with rollback capability, providing complementary defense-in-depth: the serving layer governs how models learn and update; the constraint enforcement layer governs what models are permitted to do at execution time.

23. The system of claim 1, wherein the constraint enforcement layer enforces constraints against proposed actions generated by the AI processing pipeline regardless of how the underlying model was trained, fine-tuned, re-aligned, or retrained from operational data, such that ad-hoc model retraining that shifts decision boundaries without explicit constraint modification events cannot circumvent the constraint hierarchy.

24. The system of claim 1, wherein the constraint enforcement layer, including the hierarchical constraint model parameters, the cryptographic verification keys, the constraint modification history, and the audit logs, is owned, operated, and controlled exclusively by the deploying entity that deploys the AI system in an operational context, independently of any technology provider supplying the AI processing pipeline, the deployer-ownership being enforced by hosting the constraint enforcement layer's persistent state on infrastructure under the deploying entity's administrative control and holding the cryptographic signing keys in a hardware security module provisioned exclusively to the deploying entity, such that provider substitution, provider coercion, or government-directed replacement of the technology provider does not affect the deploying entity's ownership, control, or operation of the constraint enforcement layer.

25. The system of claim 1, wherein the property that no pathway exists from the AI processing pipeline to the action execution interface that bypasses the constraint enforcement layer is enforced at multiple architectural layers comprising: (a) a software architecture layer in which the action execution interface exposes no API, endpoint, message queue, shared memory segment, or database table accessible to the AI processing pipeline except through the constraint enforcement layer's evaluation interface; (b) an operating system and network layer in which the AI processing pipeline and action execution interface execute in separate processes or containers with separate network identities and firewall rules permitting the AI processing pipeline to communicate only with the constraint enforcement layer; and (c) a provider-independence verification step that confirms, following any provider substitution event, that no new communication channel has been established between the AI processing pipeline and the action execution interface outside the constraint enforcement layer.

26. The system of claim 4, wherein the first tier inviolable constraints are stored in one of: (a) a hardware security module (HSM) conforming to FIPS 140-3 Level 3 or higher, accessible only through the HSM's authenticated command interface; (b) a trusted platform module (TPM 2.0) with constraints sealed to a known platform configuration register state, such that tampering with the execution environment breaks the seal and prevents constraint loading; (c) a one-time-programmable (OTP) memory region that is physically unwritable after provisioning; or (d) a code-signing-protected firmware image where the constraint parameters are embedded in a read-only data section verified by a secure boot chain; and wherein the cryptographic signing key used to sign the first tier constraints is generated and retained exclusively within a hardware security module controlled by the deploying entity, with the private key never leaving the HSM in plaintext form.

27. The system of claim 1, wherein the AI processing pipeline comprises an autonomous personal assistant agent that generates proposed actions governing digital task automation, communication management, and digital service operations on behalf of an individual user, and the first tier inviolable constraints comprise at least: a prohibition on initiation or authorization of financial transactions without biometric or multi-factor user authentication verified through an out-of-band channel; a prohibition on transmission, storage, or disclosure of user credentials, authentication tokens, or cryptographic secrets to any external service or skill module; a prohibition on permanent and irrecoverable deletion of user data without explicit per-item user confirmation; and a prohibition on transmission of communications to external recipients on behalf of the user without user approval when the communication exceeds a governance-defined sensitivity threshold.

28. The system of claim 27, wherein the constraint enforcement layer further implements: (a) a risk-tiered action authorization model wherein each proposed action is classified into a low-risk tier permitting autonomous execution, a medium-risk tier permitting autonomous execution with post-action notification to the user, or a high-risk tier requiring explicit pre-action user confirmation, the risk classification for each action type being stored in the second tier governance-modifiable constraints; and (b) a skill module isolation architecture wherein each integrated digital service operates within a sandboxed execution context with access limited to data categories and action permissions defined in the second tier constraints for that integration, no skill module having access to credentials, authentication tokens, or data belonging to other service integrations, and cross-integration data flow requiring explicit permission in the second tier data sharing policy.

29. The system of claim 1, wherein the AI processing pipeline comprises an executive decision support agent, and the first tier inviolable constraints comprise at least: a prohibition on transmission of material non-public information outside authenticated insider channels; a prohibition on disclosure of board-privileged materials to recipients not authenticated as board members or authorized insiders; and a prohibition on autonomous commitment of organizational resources exceeding a compiled authority threshold.

30. The system of claim 29, wherein the constraint enforcement layer further prohibits any communication on behalf of the executive during regulatory quiet periods or trading blackout windows without explicit executive confirmation through a verified out-of-band channel.

31. The system of claim 1, wherein the AI processing pipeline comprises a regulated communications compliance monitoring agent, and the first tier inviolable constraints comprise at least: pre-transmission evaluation of all outbound communications against regulatory prohibition patterns before the communication is transmitted; a prohibition on transmission of communications containing material non-public information outside designated channels; a prohibition on transmission of protected health information outside encrypted HIPAA-compliant channels; and mandatory tamper-evident archival of all business communications with retention periods satisfying applicable regulatory requirements.

32. The system of claim 31, wherein second tier governance-modifiable constraints comprise supervision thresholds defining which communication categories require pre-transmission supervisor review versus post-transmission sampling review, and lexicon-based flagging rules configurable by a designated compliance officer through the constraint modification governance pipeline.

33. The system of claim 1, wherein the AI processing pipeline comprises a patient health advocacy agent operating on behalf of an individual patient, and the first tier inviolable constraints comprise at least: an absolute prohibition on making clinical decisions or generating treatment recommendations; a prohibition on accessing provider systems beyond read-only data retrieval for the specific patient; a prohibition on sharing patient health information outside HIPAA-compliant encrypted channels; and
mandatory immediate escalation of any adverse event indicator to the clinical team and designated caregiver.

34. The system of claim 33, wherein the constraint enforcement layer generates a hash-chain audit trail documenting every interaction between the patient advocacy agent and every provider system, insurance company, and pharmacy, the audit trail being reviewable by the patient, a designated caregiver, or a healthcare ombudsman.

35. The system of claim 1, further configured as a governance-as-a-service middleware platform comprising: (a) a standardized application programming interface specification through which a third-party AI processing pipeline submits proposed actions for constraint evaluation; (b) a governance configuration interface through which a deploying entity configures the hierarchical constraint model; (c) a deployer-owned persistent state store maintaining constraint parameters, modification history, cryptographic verification keys, and audit logs independently of both the middleware provider and the third-party AI processing pipeline provider; and (d) wherein no pathway exists from the third-party AI processing pipeline to any action execution interface that bypasses the constraint evaluation provided through the API specification.

36. The system of claim 35, wherein provider-independence operates at two levels: the deploying entity can substitute the third-party AI processing pipeline without affecting the constraint enforcement layer, and the deploying entity can substitute the middleware provider without losing constraint state, modification history, or audit records, the two-level provider-independence being enforced by separation of the deployer-owned persistent state store from both the middleware runtime and the AI processing pipeline runtime.
